(19) United States
(12) Patent Application Publication
(10) Pub. No.: US 2026/0251197 A1
(43) Pub. Date: Aug. 27, 2026

(54) ELASTOMER BEARINGS WITH BULGING BY COMPRESSION

(71) Applicant: Vibracoustic SE, Weinheim (DE)

(72) Inventors: Hilrich Kardoes, Winsen (DE); Philipp Werner, Lüneburg (DE); Michael Meß, Seevetal (DE)

(21) Appl. No.: 19/421,673

(22) Filed: Dec. 16, 2025

(30) Foreign Application Priority Data
Dec. 17, 2024 (DE) 10 2024 138 437.9

(51) Int. Cl. F16F 1/38; F16C 27/02; F16C 27/06; F16C 33/20

(52) U.S. Cl. CPC F16F 1/3856; F16C 27/02; F16C 27/063; F16C 33/208; F16C 2208/02; F16C 2220/02; F16F 2226/04

(57) ABSTRACT

There is proposed an elastomeric bearing (2) having an inner sleeve (4), which forms at least one upsetting geometry (12) at the outer circumference, wherein the at least one upsetting geometry (12) induces a compressive stress in an elastomeric body (10).

Elastomeric bearings are known from practice. They comprise an inner sleeve, an outer sleeve, and an elastomeric body, which connects the two together elastically.

It is known that a pipe that is held at its ends between two faces and is compressed bulges in the middle as long as the pipe is prevented from buckling (4^{th} Euler buckling case). Thick-walled, cylindrical inner sleeves, as can be used in elastomeric bearings, can thus be contoured in the middle without the inner sleeve having to be shaped by means of material-removing turning.

In order to reduce tensile stresses in an elastomeric bearing that are caused by shrinkage of elastomeric material during cooling, it is conventional to calibrate elastomeric bearings from outside. To this end, the outer sleeve can be plastically deformed and/or its diameter can be reduced. Slotted bushes can also be used. Slotted bushes additionally have the advantage that, when a slotted intermediate plate is used in the elastomeric body, the radially inner elastomer track can also be calibrated. If it is not possible to use slotted bushes or if external calibration cannot be carried out or if unslotted intermediate plates are used, calibration “from inside” via the inner sleeve must be considered.

Such calibration is carried out by means of expansion. In this method, a mandrel that is larger than the bore of the inner sleeve is pushed through the inner sleeve. The outside diameter of the inner sleeve is thus increased; compressive stresses are induced in the surrounding elastomer. However, the inner sleeve is widened over its entire length. The original shape is thus largely retained: a cylinder, for example, is still a cylinder. The degree of expansion is also limited because, if the degree of expansion is too high, the inner sleeve can tear and wear of the mandrel also increases, and the necessary forces increase.

Elastomeric bearings with plastics outer sleeves are further known, such bearings not being calibratable from outside owing to a lack of plasticity of the material. It is here conventional, by contrast, to press such bearings into an eye of small diameter and in so doing reduce the diameter of the plastics outer sleeve, thus performing calibration. However, this requires pressing in and the associated frictional connection between the plastics outer sleeve and the receiving eye. Bushes that are fixed, for example, only by means of positive connection, for example because they are wrapped with carbon fiber-reinforced plastic and the receiving eye is then produced by means of curing, cannot be calibrated in this way.

A solution for improved calibration of elastomeric bearings is therefore to be found.

This object is achieved with the elastomeric bearing of claim 1, the assembly group as claimed in claim 7 and the methods as claimed in claims 11, 12 and 13. Embodiments are the subject matter of the dependent claims.

The invention relates to an elastomeric bearing comprising an inner sleeve, an outer sleeve, which surrounds the inner sleeve at the outer circumference with the formation of a gap, and an elastomeric body, which is arranged in the gap and connects the sleeves together, wherein the inner sleeve forms at the outer circumference at least one upsetting geometry, wherein the at least one upsetting geometry induces a compressive stress in the elastomeric body.

It has been recognized that, by upsetting the inner sleeve after the elastomeric body has been vulcanized, a widening of the outside diameter of the inner sleeve is achieved, which solves the problems of the prior art. As a result, high calibration rates are possible, because the upsetting introduces into the inner sleeve primarily compressive stresses and fewer tensile stresses at the circumference compared to expansion. The upsetting geometry induces a calibrating compressive stress in the already existing elastomeric body. During the upsetting, the cross section is increased at least in some regions and the length is reduced.

The upsetting geometry induces compressive stresses in the elastomeric bearing and optimizes the tensile stress distribution in the elastomeric body. Thus, the service life of the elastomeric body also increases. The upsetting geometry can comprise at least one bead and/or a trough delimited on both sides by two beads. The upsetting geometry is shaped from the inner sleeve.

The outer sleeve can be an uncalibrated and/or uncalibratable outer sleeve. The outer sleeve can be an outer sleeve that is uncalibrated in the preassembled state. Because the calibration is carried out from inside via the inner sleeve, calibration no longer has to take place from outside. This makes possible new freedoms of design for the outer sleeve, for example in respect of the geometry and/or material thereof. The outer sleeve can be an outer sleeve that is uncalibrated in the assembled state. Because the calibration is carried out from inside via the inner sleeve, calibration no longer has to take place from outside. The outer sleeve can be an unslotted outer sleeve.

The inner sleeve is an upset inner sleeve. Before upsetting, the inner sleeve can be a hollow cylinder, preferably a hollow cylinder in the mathematical sense. Before the upsetting, the inner sleeve has a starting length between its end faces and a starting outside diameter. After the upsetting, the inner sleeve has an upset length between its end faces that is smaller than the starting length and its starting outside diameter is likewise increased, at least in some regions. The inner sleeve can be upset by more than 2%, preferably more than 4%, particularly preferably more than 8%. Upsetting by more than 10%, more than 15%, more than 20% or more than 25% is conceivable. It has been shown that the invention makes possible calibration rates far beyond known upsetting, without the inner sleeve tearing. The central longitudinal axis passes through the inner sleeve. The inner sleeve can be mirror-symmetrical with respect to a transverse midplane and/or rotationally symmetrical with respect to the central longitudinal axis. After upsetting, the inner sleeve can have an outside diameter that is not increased over its entire length. After the upsetting, the inner sleeve can have an outside diameter that is increased only in part. Regions of the inner sleeve, for example its end faces, can thus remain free of an increase in outside diameter. The inner sleeve of the elastomeric bearing is a calibrated inner sleeve. The inner sleeve is upset for calibration of the elastomeric bearing, preferably the calibration of the elastomeric bearing is carried out solely through the inner sleeve. The inner sleeve has on the outer circumference an outer circumferential surface. The upsetting geometry is located on the outer circumference of the inner sleeve. The inner sleeve can have a fastening bore, which extends along the central longitudinal axis. The fastening bore can be a through-bore. In the through-bore, the inner sleeve has an inner circumferential surface. A fastening element, for example a bolt or a screw, can engage into the fastening bore. The inner sleeve is thus able to be fastened to a component in the assembled state. The inner sleeve can have an end face axially at both ends. The end faces can have an outside diameter. It is conceivable that these outside diameters do not undergo an increase as a result of the upsetting. These outside diameters can correspond to the starting outside diameter.

The upsetting geometry is a geometry that has been formed by upsetting of the inner sleeve. The upsetting geometry is a plastic deformation of the inner sleeve. The inner sleeve is upset along its central longitudinal axis. The upsetting geometry is formed into the elastomeric body and/or forms in the radial direction toward the elastomeric body. The inner sleeve can comprise a single upsetting geometry. The upsetting geometry projects in the radial direction. The upsetting geometry can extend in the circumferential direction, preferably throughout. Uniform calibration at the circumference is thus possible. An upset geometry is viewable in the inner sleeve, for example by a corresponding surface structure of the inner sleeve, which forms as a result of flowing of the material on upsetting. The central longitudinal axis passes through the upsetting geometry. The upsetting geometry can be mirror-symmetrical with respect to a transverse midplane and/or rotationally symmetrical with respect to the central longitudinal axis.

The elastomeric body is subjected to compressive stress by the upsetting geometry. This compressive stress acts in the radial direction. This is demonstrable, for example, in that: When the outer sleeve is removed, the outside diameter of the elastomeric body increases. The elastomeric body can be pressed against the outer sleeve or uncalibrated outer sleeve by the upsetting geometry or calibrated inner sleeve. The elastomeric body can form a common contact face with the upsetting geometry. The central longitudinal axis passes through the elastomeric body. The elastomeric body can be mirror-symmetrical with respect to a transverse midplane and/or rotationally symmetrical with respect to the central longitudinal axis. The elastomeric body can be attached to the outer circumferential surface of the inner sleeve by substance-to-substance bonding, preferably by vulcanization. The elastomeric body can be attached to the inner circumferential surface of the outer sleeve by substance-to-substance bonding, preferably by vulcanization, or can rest there without substance-to-substance bonding. The elastomeric body can be an integral elastomeric body. The elastomeric body can elastically connect the inner sleeve to the outer sleeve and/or can be free of an intermediate plate. The intermediate plate can separate the elastomeric body into a radially inner and a radially outer elastomer track. The absence of an intermediate plate serves to make the elastomeric body calibratable in the radial direction throughout. The elastomeric body, when viewed in longitudinal section, can have a constriction. The length of the constriction is the shortest distance in the axial direction between the opposite end faces of the elastomeric body.

The central longitudinal axis passes through the elastomeric bearing. The elastomeric bearing can be mirror-symmetrical with respect to a transverse midplane and/or rotationally symmetrical with respect to the central longitudinal axis. The elastomeric bearing can be a bearing bush.

According to a development, the upsetting geometry can have an outside diameter that is larger than an outside diameter at the end face of the inner sleeve, preferably the upsetting geometry is or comprises at least one upsetting annular bead and/or at least one upsetting trough. The upsetting annular bead and/or the upsetting trough have/has a larger outside diameter than the starting outside diameter. Along the central longitudinal axis, the upsetting trough can be formed between two upsetting annular beads. The upsetting annular bead and/or the upsetting trough are/is generated by means of compression.

It is conceivable that the upsetting geometry or the inner sleeve comprises only a single upsetting annular bead. This can be achieved, for example, by means of a suitable choice of material for the inner sleeve. The single upsetting annular bead can be arranged in the transverse midplane and/or arranged centrally in the elastomeric bearing. Such an upsetting annular bead serves to induce high compressive stresses in the elastomeric body and spreading in the direction of high radial stiffness where cardan and in some cases also axial stiffness tends to be low. Furthermore, the elastomeric body is calibrated centrally via the inner sleeve, that is to say where the cushion of the elastomeric body is arranged. The service life of the bearing is thus increased and the stiffness is increased. This occurs as a result of the compressive stresses induced by the calibration. Such an upsetting annular bead leads, at a given stiffness, to more uniform expansions in the elastomeric body compared to a cylindrical inner sleeve. This increases the service life of the bearing further.

It is conceivable that the largest outside diameter of at least one upsetting annular bead, preferably of at least two upsetting annular beads, is present in the radial direction outside a shortest constriction of the elastomeric body. The main part of the elastomeric body, or the cushion thereof, can thus be well supported in the axial direction between the two upsetting annular beads.

It is conceivable that the upsetting geometry or the inner sleeve comprises two upsetting annular beads and the upsetting trough. This can be achieved, for example, by means of a suitable choice of material and/or geometry for the inner sleeve. The two upsetting annular beads and/or the upsetting trough can be mirror-symmetrical with respect to a transverse midplane and/or rotationally symmetrical with respect to the central longitudinal axis. The upsetting trough can merge into the upsetting annular beads on both sides along the central longitudinal axis. Such profiles do not form corners that damage the elastomer. It is an advantage of the two upsetting annular beads that the elastomer can be supported axially thereon under a corresponding load, so that axial migration is reduced. By means of the upsetting annular beads and the upsetting trough, spreading of the characteristics in the direction of high axial and radial stiffness with at the same time low torsional stiffness is promoted. Furthermore, although the upsetting trough forms an annular well for the elastomeric body, it nevertheless calibrates it. The upsetting trough has an outside diameter that is smaller than one or both outside diameter(s) of the two adjacent upsetting annular beads. The outside diameter of the upsetting trough is larger than a diameter at the same point of the inner sleeve before the upsetting (starting outside diameter).

It is conceivable that the upsetting annular bead has a convex contour, based on the central longitudinal axis. It is conceivable that the upsetting trough has a concave contour, based on the central longitudinal axis. Such profiles do not form corners that damage the elastomer.

According to a development, the upsetting geometry forms, in the transverse midplane of the elastomeric bearing, a central diameter that is larger than an outside diameter at the end face of the inner sleeve or a starting diameter at the end face of the inner sleeve. The central diameter is a central outside diameter. It can thus be ensured that the elastomeric body is subjected to compressive stress in the transverse midplane.

According to a development, the elastomeric body can be subjected to pressure in the radial direction in the transverse midplane at the outer circumference of the upsetting geometry. Depending on the calibration rate generated by the upsetting, the tensile stresses present in the elastomeric body after vulcanization and subsequent cooling as a result of thermal shrinkage can be compensated for in part or completely by the upsetting geometry.

According to a development, the outer sleeve can be manufactured from a plastics material or a fiber-plastics composite material, preferably from a thermoplastic material, preferably the outer sleeve has on the outer circumference at least one undercut element, for example a rib, at least one pocket and/or at least one thickening. The rib, pocket and/or thickening serves for fixing the elastomeric bearing preferably in the axial direction and/or circumferential direction in the receiving eye. The undercut element or the rib, pocket and/or thickening can form a positive connection, preferably solely a positive connection, with the receiving eye. Calibrating upsetting according to the invention of the inner sleeve can also be advantageous in particular when the elastomeric bearing is provided with a plastics outer sleeve that cannot be delivered in the calibrated state owing to the material. As a result of the positive connection, the elastomeric bearing is sufficiently well fixed in/to the receiving eye, so that there does not need to be a frictional connection between the outer sleeve and the receiving eye. The positive connection can fix the outer sleeve in the receiving eye in the three translational directions (X, Y, Z in the cartesian coordinate system) as well as in at least two rotational directions, preferably three rotational directions (rotation about X, Y, Z).

It is conceivable that the inner sleeve is manufactured from aluminum or steel. In particular where aluminum is used, particularly high outside diameter increases of more than 10% compared to the starting diameter can be achieved, such increases going far beyond known expansion rates of 2%. Significant compressive stresses could thus be introduced into the elastomeric body.

It is conceivable that the inner sleeve has a wall thickness of more than 5 mm. The inner sleeve can thus be upset particularly well and is sufficiently stable.

It is conceivable that the inner sleeve is manufactured from steel, wherein the upsetting geometry or inner sleeve comprises only a single upsetting annular bead. The wall thickness of the inner sleeve can be more than 5 mm.

It is conceivable that the inner sleeve is manufactured from aluminum and has a wall thickness of more than 5 mm, wherein the upsetting geometry or inner sleeve comprises exactly two upsetting annular beads and one upsetting trough. The upsetting geometry can thus extend over a long axial region. It has been recognized, surprisingly, that in the case of inner sleeves of aluminum with wall thicknesses of at least 5 mm, the formation of two upsetting annular beads can be achieved.

It is conceivable that the longitudinal sectional contour of the outer circumferential surface of the inner sleeve deviates more greatly from a straight line (parallel to the central longitudinal axis) than does the longitudinal sectional contour of the inner circumferential surface of the inner sleeve. The inner sleeve can be deformed more greatly at the outer circumference than at the inner circumference. The deformation takes place as a result of the upsetting. Thus, a fastening element is able to pass through the through-bore even after the upsetting.

According to a development, the outer sleeve can form at each of its two axial ends a fully encircling collar, said collars extending at least 3 mm in the radial direction and being able to fix the elastomeric bearing in both axial directions by means of positive connection. By means of these collars, the elastomeric bearing can be fixed in both axial directions by positive connection, preferably in the receiving eye. An overlap of the collars and receiving eyes can be at least 3 mm. Because the collars extend at least 3 mm in the radial direction, on the one hand the elastomeric bearing is reliably prevented from slipping through. On the other hand, the collars have advantages in terms of manufacture: if the elastomeric bearing is provided in an assembly group of a duroplastic plastics material, resin-impregnated semifinished product can be placed around the bearing before the component is placed in a heating press and cured there. The two collars in this case serve as a positioning aid during placing of the semifinished product.

It is additionally conceivable that the collars are fully encircling at least in the region of 3 mm radial extent. Consequently, they are not interrupted in this region. The collars are thus particularly robust under axial load and break only under very high axial forces.

According to the invention there is additionally proposed an assembly group comprising a receiving eye of an attachment structure and an elastomeric bearing according to the disclosure comprising an outer sleeve of plastics material or a fiber-plastics composite material, wherein the outer sleeve is fixed to and/or in the receiving eye.

The advantages already described above in relation to the elastomeric bearing are obtained analogously also for the assembly group, and reference is hereby made thereto.

If the elastomeric bearing does not have undercut elements that prevent the elastomeric bearing from being pressed into a receiving eye, such as a rib or pocket that does not protrude, then the elastomeric bearing can be pressed into an eye and fixed there by means of frictional connection. The elastomeric bearing can be pressed into the receiving eye. Alternatively, the receiving eye can be produced on the outer circumference of the outer sleeve. Before the elastomeric bearing is pressed into the receiving eye or the receiving eye is formed on the outer sleeve, the elastomeric bearing is then in the preassembled state. After assembly (e.g. pressing in) or formation of the receiving eye on the outer sleeve, it is in the assembled state. The receiving eye has a fastening region for the elastomeric bearing. The elastomeric bearing has a fastening region for the receiving eye. The outer sleeve can form a press-fit or form-fit for fastening to the receiving eye. The receiving eye can have in its fastening region an inside diameter that is smaller than the outside diameter of the outer sleeve in its fastening region prior to assembly. The difference between the outside diameter of the outer sleeve in its fastening region (in the preassembled state) and the inside diameter of the receiving eye in its fastening region can be in the range from 0.5% to 1.5% of the inside diameter of the receiving eye in its fastening region.

The receiving eye can be formed around the outer sleeve in a hot-pressing process. Consequently, the elastomeric bearing cannot be calibrated from outside at all or can be calibrated from outside only very slightly. This is the case in particular for an outer sleeve and/or a receiving eye of plastics material. Advantageously, the elastomeric bearing can be calibrated from inside via the inner sleeve, so that it can comprise an outer sleeve and plastics material. It is conceivable that the elastomeric bearing is calibrated by upsetting of the inner sleeve prior to the hot-pressing process.

According to a development, the receiving eye can be a plastics eye, wherein the plastics material is a thermoplastic fiber-plastics composite material or a duroplastic fiber-plastics composite material. The receiving eye can consist of a thermoplastic or a duroplastic plastics material.

If the receiving eye is made of a duroplastic fiber-plastics composite material, then a resin-impregnated semifinished product can first be placed around the elastomeric bearing, which semifinished product can also form the remainder of the attachment structure. The unit of resin-impregnated semi-finished product and at least one elastomeric bearing can then be placed in a hot press, where the assembly group can be pressed into its final form and thermally cured.

Alternatively, it is also possible to use for the receiving eye a preheated, resin-impregnated thermoplastic semifinished product, which can be placed together with the elastomeric bearing in a hot press and which, as a result of the subsequent pressing process, flows around the elastomeric bearing, forms the receiving eye and then cures by means of cooling below the melting point.

It is likewise theoretically conceivable to place the elastomeric bearing in an injection-molding machine and overmold it with a thermoplastic fiber-reinforced plastics material in order to form the receiving eye.

It is common to all three methods that almost no compressive stresses acting on the outer sleeve from outside are induced in the outer sleeve by the receiving eye. Rather, the plastic semi-finished product forming the attachment structure is capable of flowing around the undercut element (rib, pocket and/or thickening) preferably formed on the outer sleeve and finally fixing the elastomeric bearing securely in the receiving eye by positive connection, preferably solely by positive connection. If the elastomeric bearing additionally has two collars, which engage around the receiving eye at least in some regions, then the two collars can together achieve further particularly secure positive connection in the axial direction, which further supports the fixing of the elastomeric bearing in the receiving eye.

According to a development, the thermoplastic or duroplastic fiber-plastics composite material can have a mean fiber length of at least 12 mm, preferably at least 25 mm, particularly preferably with a mean fiber length of at least 50 mm. It is thus possible to use materials that are suitable less for processing by means of injection molding and more for processing by the pressing method.

According to a development, the receiving eye can be an integral eye. Advantageously, the receiving eye in the form of a plastics eye is an integral eye. The eye is thus closed and not split, so that an additional processing step does not have to take place, for example screwing together of the two eye halves. The elastomeric bearing can thus be non-detachably fixed in a particularly secure manner by means of undercuts.

According to the invention there is additionally proposed a method for producing an elastomeric bearing, comprising at least the following steps in this order:
providing an inner sleeve and an outer sleeve,
vulcanizing an elastomeric body in a gap between the inner sleeve and the outer sleeve in order to connect the sleeves together,
upsetting the inner sleeve by applying a force to at least one of the end faces of the inner sleeve in order to form an upsetting geometry of the inner sleeve.

The advantages already described above in relation to the elastomeric bearing and the assembly group are obtained analogously also for the method, and reference is hereby made thereto. The elastomeric bearing that is produced can be an elastomeric bearing according to the disclosure. The upsetting serves for calibration.

The upsetting can take place by applying the force to only one end face of the inner sleeve or by applying mutually opposite forces to both end faces of the inner sleeve. Before the upsetting, the inner sleeve can be arranged via its end faces between two pressure plates. This serves for a uniform force introduction and the high-quality generation of the upsetting geometry. It is conceivable that each of the pressure plates has a centering projection, which engages into the fastening bore of the inner sleeve. This serves to secure the elastomeric bearing during upsetting and to support the fastening bore in the inner sleeve, which further reduces/prevents a reduction in the diameter of the fastening bore.

According to a conceivable development, cooling of the vulcanized elastomeric body can be provided before the upsetting. It is expedient that the elastomeric bearing is completely cooled, preferably has been stored for at least 12 hours, before the upsetting is provided. This ensures that crosslinking in the elastomeric body is almost complete and calibration by the upsetting thus leads particularly effectively and lastingly to compressive stresses in the elastomeric body.

According to a conceivable development,
assembly of the elastomeric bearing on and/or in the receiving eye can be carried out, after which the step of upsetting can be carried out. Upsetting after assembly permits upsetting “in situ”.

According to a conceivable development,
assembly of the elastomeric bearing on and/or in the receiving eye can be carried out after the step of upsetting has been carried out. Upsetting before assembly serves for more advantageous handling of the elastomeric bearing.

According to the invention there is additionally proposed a method for producing an assembly group, comprising at least the following steps in this order:
wrapping the elastomeric bearing comprising an upset inner sleeve with a resin-impregnated duroplastic semifinished product,
placing the wrapped elastomeric bearing into a mold of a hot press,
closing the hot press and curing the resin-impregnated duroplastic semifinished product to form a receiving eye in which the outer sleeve is fixed,
removing the assembly group comprising the elastomeric bearing and the receiving eye.

The receiving eye can thus first be produced around the outer sleeve. The method is particularly advantageous when the outer sleeve is made of plastics material. Calibration is then carried out via the inner sleeve and does not have to take place via the outer circumference and/or by pressing into an eye. The production method can also generate the attachment structure of the receiving eye (curing of the resin-impregnated semifinished product to form an attachment structure with a receiving eye in which the outer sleeve is fixed).

The advantages already described above in relation to the elastomeric bearing, the assembly group and the method are obtained analogously also for the method, and reference is hereby made thereto.

According to the invention there is additionally proposed a method for producing an assembly group, comprising at least the following steps in this order:
thermally plasticizing a semifinished product of fiber-plastics composite material with a mean fiber length of at least 12 mm,
placing the plasticized semifinished product and an elastomeric bearing into a mold of a hot press,
closing the hot press and forming a receiving eye in which the outer sleeve is fixed.

The assembly group can be cooled in the mold until the assembly group is at least dimensionally stable, and then demolded.

Upsetting of the inner sleeve can be carried out before placing into the pressing mold or after the assembly group has been produced.

The production method can also generate the attachment structure of the receiving eye (closing of the hot press and forming of an attachment structure with a receiving eye in which the outer sleeve is fixed).

The advantages already described above in relation to the elastomeric bearing, the assembly group and the method are obtained analogously also for the mentioned method, and reference is hereby made thereto.

Directions and references, such as axial direction, radial direction, circumferential direction, transverse midplane, cross section, longitudinal section, relate to the central longitudinal axis.

In the preassembled state, the elastomeric bearing is not yet fastened in/to the receiving eye. In the assembled state, the elastomeric bearing is fastened in/to the receiving eye.

It should be noted that the elements described herein are disclosed in principle as components that are separate from one another. Reference may be made to integral forms.

Further features, details and advantages of the invention will become apparent from the wording of the claims and from the following description of exemplary embodiments with reference to the drawings, in which:

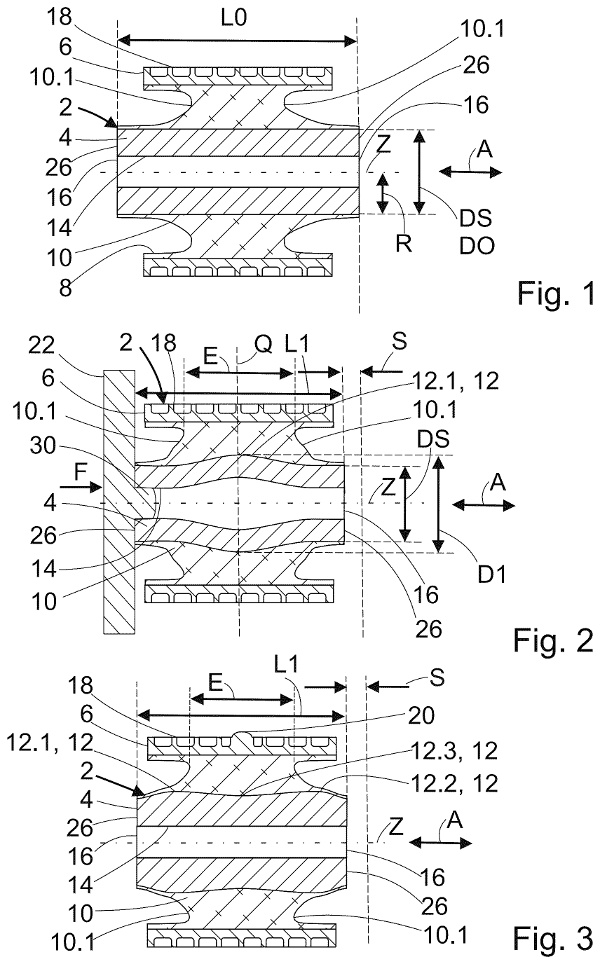

FIG. 1 shows an elastomeric bearing before the upsetting,

FIG. 2 shows an elastomeric bearing of a first form after the upsetting,

FIG. 3 shows an elastomeric bearing of a second form after the upsetting,

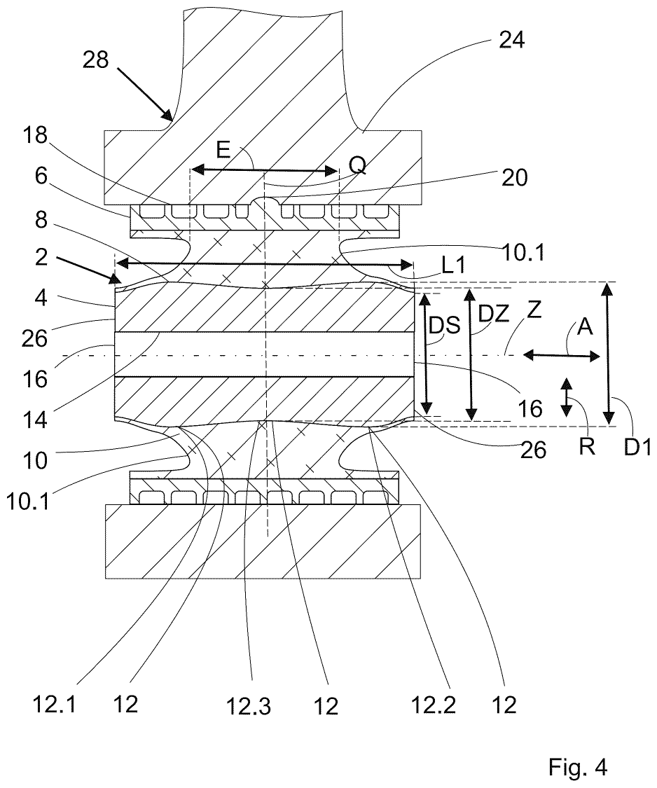

FIG. 4 shows the elastomeric bearing of FIG. 3 in a detail view in an attachment structure,

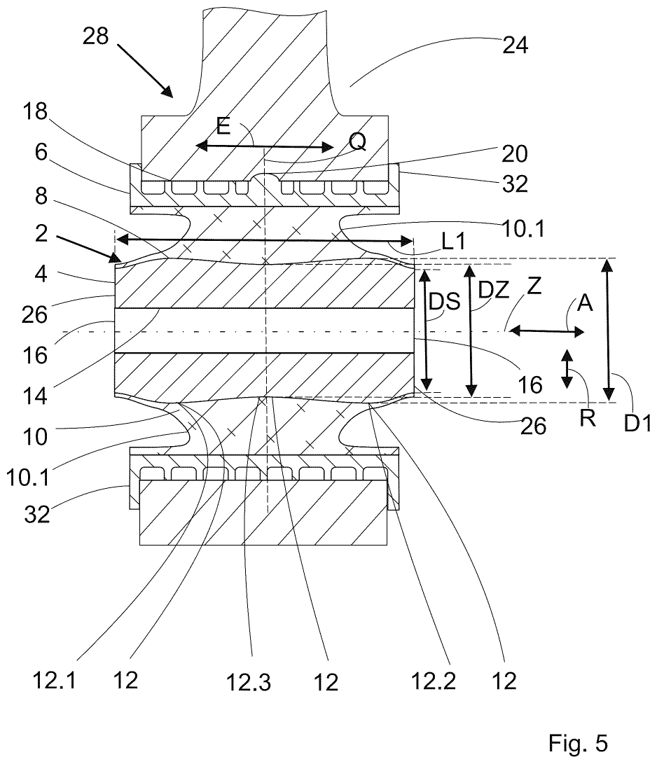

FIG. 5 shows an elastomeric bearing with collars in an attachment structure, and

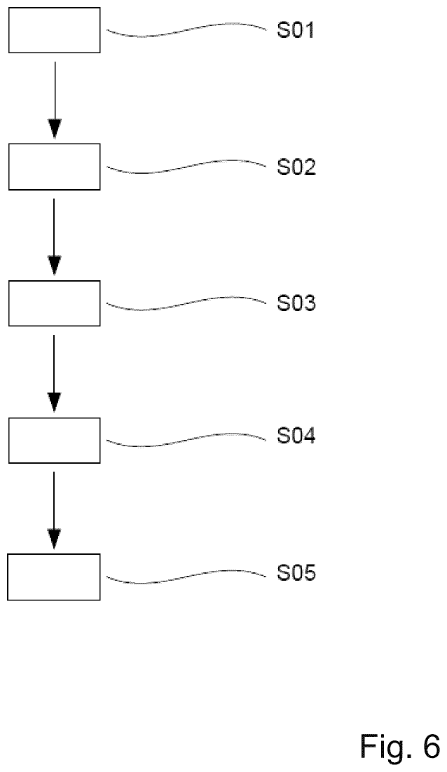

FIG. 6 shows a flow diagram of a method.

In the figures, identical or mutually corresponding elements are in each case denoted by the same reference signs and therefore, unless expedient, are not described again. Features which have already been described are not described again in order to avoid repetition and are applicable to all elements with the same or mutually corresponding reference signs, unless explicitly excluded. The disclosures contained in the description as a whole are applicable analogously to the same parts with the same reference signs or the same component designations. The position information chosen in the description, such as, for example, top, bottom, lateral, etc., is also related to the figure that is directly being described and depicted and in the case of a change in position is to be transferred analogously to the new position. Furthermore, individual features or feature combinations from the different exemplary embodiments that are shown and described can also represent independent solutions that are inventive or in accordance with the invention.

A central longitudinal axis Z is given. An axial direction A is parallel to the central longitudinal axis Z. A radial direction R extends perpendicular to the central longitudinal axis Z. A circumferential direction U extends around the central longitudinal axis Z, and a transverse midplane Q is arranged such that the normal vector thereof lies on the central longitudinal axis Z. The central longitudinal axis Z lies within a longitudinal sectional plane.

FIGS. 1 to 4 show in each case an elastomeric bearing 2 in longitudinal section, said elastomeric bearing being a bearing bush. The central longitudinal axis Z passes through the elastomeric bearing 2 in the axial direction A.

The elastomeric bearing 2 comprises an inner sleeve 4. The inner sleeve 4 is here mirror-symmetrical with respect to the transverse midplane Q and rotationally symmetrical with respect to the central longitudinal axis Z. Before an upsetting S04, the inner sleeve 4 is an inner sleeve 4, in the form of a hollow cylinder, that has not been upset (FIG. 1), and after the upsetting S04 it is an upset inner sleeve 4 (FIGS. 2-4). The inner sleeve 4 has a fastening bore 14, which extends along the central longitudinal axis Z and is a through-bore 14. The through-bore 14 therefore additionally has at both ends of the inner sleeve 4 an opening 16. In the through-bore 14, the inner sleeve 4 has an inner circumferential surface. The inner sleeve 4 has axially at both ends an end face 26. As a result of the upsetting S04, the inner sleeve 4 forms on the outer circumference an upsetting geometry 12 (FIGS. 2-4), which is shaped from the inner sleeve 4 itself.

The upsetting geometry 12 is a plastic deformation of the inner sleeve 4. The upsetting geometry 12 projects in the radial direction R and extends in the circumferential direction U throughout. The upsetting geometry 12 is here mirror-symmetrical with respect to the transverse midplane Q and also rotationally symmetrical with respect to the central longitudinal axis Z. The upsetting geometry 12 has an outside diameter that is larger than the outside diameter DS at the end face of the inner sleeve 4, here denoted D1. The upsetting geometry 12 can comprise an upsetting annular bead 12.1, 12.2, which has a convex contour based on the central longitudinal axis Z, and/or an upsetting trough 12.3, which has a concave contour based on the central longitudinal axis Z.

The elastomeric bearing 2 comprises an unslotted outer sleeve 6. The outer sleeve 6 surrounds the inner sleeve 4 at the outer circumference and in so doing forms a gap 8. The outer sleeve 6 is an uncalibrated and uncalibratable outer sleeve 6 of plastics material. The outer sleeve 6 has on the outer circumference at least ribs 18 and in FIG. 3 additionally a thickening 20, which are undercut elements and are configured to form an undercut with a receiving eye (not shown).

The elastomeric bearing 2 additionally comprises an integral elastomeric body 10, which is arranged in the gap 8 and elastically connects the inner sleeve 4 to the outer sleeve 6. It has been produced by vulcanization S02 and is free of an intermediate plate. By means of vulcanization S02, the elastomeric body 10 is both attached by substance-to-substance bonding to the outer circumferential surface of the inner sleeve 4 and attached by substance-to-substance bonding to the inner circumferential surface of the outer sleeve 6. The elastomeric body 10 is subjected to compressive stress in the radial direction R by the upsetting geometry 12. The elastomeric body 10 forms a common contact face with the upsetting geometry 12, and the central longitudinal axis Z passes through the elastomeric body. The elastomeric body 10 is mirror-symmetrical with respect to the transverse midplane Q and rotationally symmetrical with respect to the central longitudinal axis Z. The elastomeric body 10 has axially at both ends an end face 10.1. When seen in longitudinal section, it has a constriction therebetween. The length of the constriction E is the shortest distance in the axial direction A between the opposite end faces 10.1 of the elastomeric body 10.

In order to calibrate the uncalibrated elastomeric bearing 2 (FIG. 1), the inner sleeve 4 is upset, the production method is shown in FIG. 5. Before the upsetting S04, the inner sleeve 4 has a starting length L0 between its end faces 26 and a starting outside diameter D0. After the upsetting S04 (FIG. 2-4), the inner sleeve 4 has an upset length L1, which is shortened compared to the starting length L0 (in the figures: L0=L1+2S).

FIG. 2 shows a first form of the upsetting geometry 12, wherein the inner sleeve 4, after the upsetting S04, is upset at both its end faces 26 by the respective distance S (for reasons relating to the illustration, indicated only at one end face) and does not have an increased outside diameter over its entire length, because its outside diameter is increased only in part. The two end regions between the upsetting geometry 12 and the end faces 26 are still cylindrical. The inner sleeve 4 is manufactured from steel. The upsetting geometry 12 of FIG. 2 has a single upsetting annular bead 12.1, which has a larger outside diameter than the starting outside diameter D0 and also than the outside diameter DS at the end face. The single upsetting annular bead 12.1 is arranged in the transverse midplane Q and centrally in the elastomeric bearing 2. Corresponding to the single upsetting annular bead 12.1, the inside diameter of the inner sleeve 4 of steel has widened.

FIG. 3 shows an inner sleeve 4 of aluminum in a second form of the upsetting geometry 12, comprising two upsetting annular beads 12.1, 12.2 and an upsetting trough 12.3 axially therebetween. The two upsetting annular beads 12.1, 12.2 and also the upsetting trough 12.3 each have a larger outside diameter than the starting outside diameter D0 and also than the outside diameter DS at the end face. The upsetting trough 12.3 is formed along the central longitudinal axis Z between the two upsetting annular beads 12.1, 12.2. The two upsetting annular beads 12.1, 12.2 and the upsetting trough 12.3 are mirror-symmetrical with respect to the transverse midplane Q and rotationally symmetrical with respect to the central longitudinal axis Z. The upsetting trough 12.3 merges on both sides along the central longitudinal axis Z into the upsetting annular beads 12.1, 12.2. The largest outside diameters D1 of the two upsetting annular beads 12.1, 12.2 are present outside the shortest constriction of the elastomeric body 10 in the radial direction R. The largest outside diameters D1 are therefore not in alignment with the constriction in the radial direction R. The upsetting geometry 12 additionally has in the transverse midplane Q an outside diameter or central diameter DZ that is smaller than an outside diameter of the upsetting geometry 12 outside the transverse midplane Q-the largest outside diameters D1 larger than the central diameter DZ are visible. The central diameter DZ is additionally larger than the outside diameter DS at the end face of the inner sleeve 4. The longitudinal sectional contour of the outer circumferential surface of the inner sleeve 4 deviates more greatly from a straight line (parallel to the central longitudinal axis Z) than does the longitudinal sectional contour of the inner circumferential surface of the inner sleeve 4.

FIG. 4 shows, by way of example, an assembled state with reference to the elastomeric bearing of FIG. 3. A fastening element, for example a bolt or a screw, can engage into the fastening bore 14. In FIG. 4 there is further shown an assembly group 28, comprising a receiving eye 24 of an attachment structure and the elastomeric bearing 2, which is fastened to and in the receiving eye 24. The elastomeric bearing 2 and the receiving eye 24 have a fastening region for the respective other element. The receiving eye 24 consists of a plastics material.

FIG. 5 shows an elastomeric bearing in the assembled state, which is identical to that shown in FIGS. 3 and 4 apart from the configuration of the outer sleeve 6. The outer sleeve 6 forms at its two axial ends a fully encircling collar 32, said collars extending at least 3 mm in the radial direction R and overlapping with the receiving eyes 24 by at least 3 mm.

FIG. 6 shows a conceivable production method for the elastomeric bearing. In step S01, the inner sleeve 4 and the outer sleeve 6 are provided. Then, in step S02, the elastomeric body 10 is produced. In the gap 8 between the inner sleeve 4 and the outer sleeve 6, the elastomeric body 10 is vulcanized. It binds to the sleeves 4, 6 by substance-to-substance bonding and connects said sleeves together. In step S03, cooling of the elastomeric body 10 is carried out. Before the upsetting S04, the elastomeric body 10 has tensile stresses, which are caused by the cooling thereof (FIG. 1). In step S04, upsetting of the inner sleeve 4 along the central longitudinal axis Z is carried out. To this end, a force F, shown by way of example in FIG. 2, is applied to at least one end face 26 of the inner sleeve 4. Before the upsetting, the inner sleeve 4 can be arranged via its end faces 26 between two pressure plates 22, likewise shown by way of example in FIG. 2. Each pressure plate 22 can have a centering projection 30, which engages in a centering manner into the fastening bore 14. The upsetting S04 has the result that the upsetting geometry 12 forms, inducing in the elastomeric body 10 a compressive stress, which acts against the tensile stress therein. The upsetting geometry 12 is formed into the elastomeric body 10 and develops in the radial direction R toward the elastomeric body 10. After step S04, assembly can take place in step S05. However, it is also conceivable that assembly takes place first and then the upsetting.

The invention is not limited to one of the embodiments described above but can be modified in a variety of ways. All the features and advantages, including structural details, spatial arrangements and method steps, that follow from the claims, the description and the drawing can be essential to the invention both on their own and in a very wide variety of combinations.

All combinations of at least two of the features disclosed in the description, the claims and/or the figures fall within the scope of the invention.

In order to avoid repetition, features disclosed in accordance with the device are also to be considered disclosed and able to be claimed in accordance with the method. Likewise, features disclosed in accordance with the method are to be considered disclosed and able to be claimed in accordance with the device.

### LIST OF REFERENCE SIGNS

2 elastomeric bearing
4 inner sleeve
6 outer sleeve
8 gap
10 elastomeric body
10.1 end face
12 upsetting geometry
12.1 upsetting annular bead
12.2 upsetting annular bead
12.3 upsetting trough
14 fastening bore
16 opening
18 rib
20 thickening
22 pressure plate
24 receiving eye
26 end face
28 assembly group
30 centering projection
32 collar
A axial direction
DS outside diameter, end
DZ outside diameter, central
D0 starting outside diameter
D1 largest outside diameter, upsetting geometry
E length of constriction
F force
L0 starting length
L1 upset length
Q transverse midplane
R radial direction
S distance
S01 provision
S02 vulcanization
S03 cooling
S04 upsetting
S05 assembly
U circumferential direction
Z central longitudinal axis

1. An elastomeric bearing (2) comprising
an inner sleeve (4),
an outer sleeve (6), which surrounds the inner sleeve (4) at the outer circumference with the formation of a gap (8), and
an elastomeric body (10), which is arranged in the gap (8) and connects the sleeves (4, 6) together, wherein
the inner sleeve (4) forms at the outer circumference at least one upsetting geometry (12), wherein the at least one upsetting geometry (12) induces a compressive stress in the elastomeric body (10).

2. The elastomeric bearing as claimed in claim 1, wherein the upsetting geometry (12) has an outside diameter that is larger than an outside diameter (DS) at the end face of the inner sleeve (4), preferably the upsetting geometry (12) is or comprises at least one upsetting annular bead (12.1, 12.2) and/or at least one upsetting trough (12.3).

3. The elastomeric bearing as claimed in claim 1, wherein the upsetting geometry (12) forms, in the transverse midplane (Q) of the elastomeric bearing (2), a central diameter (DZ) that is larger than an outside diameter (DS) at the end face of the inner sleeve (4).

4. The elastomeric bearing as claimed inclaim 1, wherein the elastomeric body (10) is subjected to pressure in the radial direction (R) in the transverse midplane (Q) at the outer circumference of the upsetting geometry (12).

5. The elastomeric bearing as claimed in claim 1, wherein the outer sleeve (6) is manufactured from a plastics material or a fiber-plastics composite material, preferably from a thermoplastic material, preferably the outer sleeve (6) has on the outer circumference at least one undercut element.

6. The elastomeric bearing as claimed in in claim 1, wherein the outer sleeve (6) forms at each of its two axial ends a fully encircling collar, said collars extending at least 3 mm in the radial direction (R) and being able to fix the elastomeric bearing (2) in both axial directions (A) by means of positive connection.

7. An assembly group comprising
a receiving eye (24) of an attachment structure and
an elastomeric bearing (2) as claimed in one of the preceding claims, comprising
an outer sleeve (6) of plastics material or a fiber-plastics composite material,
wherein the outer sleeve (6) is fixed to and/or in the receiving eye (24).

8. The assembly group as claimed in claim 7, wherein the receiving eye (24) is a plastics eye, wherein the plastics material is a thermoplastic fiber-plastics composite material or a duroplastic fiber-plastics composite material.

9. The assembly group as claimed in claim 8, wherein the thermoplastic or duroplastic fiber-plastics composite material has a mean fiber length of at least 12 mm, preferably at least 25 mm, particularly preferably with a mean fiber length of at least 50 mm.

10. The assembly group as claimed in claim 7, wherein the receiving eye (24) is an integral eye.

11. A method for producing an elastomeric bearing (2), comprising at least the following
steps in this order:
providing an inner sleeve (4) and an outer sleeve (6),
vulcanizing an elastomeric body (10) in a gap (8) between the inner sleeve (4) and the outer sleeve (6) in order to connect the sleeves (4, 6) together,
upsetting the inner sleeve (4) by applying a force (F) to at least one of the end faces of the inner sleeve (4) in order to form an upsetting geometry (12) of the inner sleeve (4).

12. A method for producing an assembly group (28), comprising at least the following steps
in this order:
wrapping the elastomeric bearing (2) comprising an upset inner sleeve (4) with a resin-impregnated duroplastic semifinished product,
placing the wrapped elastomeric bearing (2) into a mold of a hot press,
closing the hot press and curing the resin-impregnated duroplastic semifinished product to form a receiving eye (24) in which the outer sleeve (6) is fixed.

13. A method for producing an assembly group (28), comprising at least the following steps
in this order:
thermally plasticizing a semifinished product of fiber-plastics composite material with a mean fiber length of at least 12 mm,
placing the plasticized semifinished product and an elastomeric bearing (2) into a mold of a hot press,
closing the hot press and forming a receiving eye (24) in which the outer sleeve (6) is fixed.
